(19) United States
(12) Patent Application Publication
(10) Pub. No.: US 2012/0028095 A1
(43) Pub. Date: Feb. 2, 2012

(54) BATTERY COVER LATCHING MECHANISM AND ELECTRONIC DEVICE USING THE SAME

(75) Inventors: LI-JUAN WANG, Shenzhen (CN); YONG-GANG ZHANG, Shenzhen (CN); KUAN-HUNG CHEN, Shindian (TW)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 13/010,933

(22) Filed: Jan. 21, 2011

(30) Foreign Application Priority Data
Jul. 28, 2010 (CN) 201010239238.1

(51) Int. Cl. H01M 2/10; E05C 1/08; E05C 19/10

(52) U.S. Cl. 429/100; 292/106; 292/128

(57) ABSTRACT

A battery cover latching mechanism employed in an electronic device is used to assemble a battery cover to a housing. The battery cover latching mechanism includes a hook, a base body, a sliding element, and an operating element. The hook is mounted on the battery cover, and the base body is detachably assembled to the housing. The sliding element is detachably and slidably assembled to the base body and includes a latching block corresponding to the hook. The operating element is detachably assembled to the sliding element, and is pushed relative to the sliding element, the operating element forces the sliding element to move relative to the base body, the latching block unlocks the hook to detach the battery cover, when the latching block locks the hook, the battery cover is latched.

### BACKGROUND

1. Technical Field

The disclosure generally relates to latching mechanisms used in electronic devices, and more particularly relates to, a latching mechanism for latching a battery cover.

2. Description of the Related Art

Batteries are widely used in various electronic devices, such as personal digital assistants (PDAs), and mobile phones, to provide power to them. To secure more stable electrical connections, the batteries are latched within a housing of the electronic device.

A typical battery cover latching assembly usually includes two or more hooks at one end of the battery cover and a locking pin protruding from other end of the battery cover. The housing defines two or more grooves and a locking hole. In assembly, the hooks are inserted into the grooves; the battery cover is pressed downwards the housing until the locking pin is inserted into the locking hole. Thus, the battery cover is detachably assembled to the housing by the latching assembly. However, removal of the battery cover may require a strong force, which may damage the locking pin, making it inconvenient to install or remove the battery.

Therefore, there is room for improvement within the art.

### BRIEF DESCRIPTION OF THE DRAWINGS

Many aspects of an exemplary battery cover latching mechanism and electronic device using the same can be better understood with reference to the following drawings. The components in the drawings are not necessarily drawn to scale, the emphasis instead being placed upon clearly illustrating the principles of the exemplary battery cover latching mechanism and electronic device using the same. Moreover, in the drawings, like reference numerals designate corresponding parts throughout the several views. Wherever possible, the same reference numbers are used throughout the drawings to refer to the same or like elements of an embodiment.

FIG. 1 is an exploded view of a battery cover latching mechanism used in an electronic device, according to an exemplary embodiment.

FIG. 2 is similar to FIG. 1, but viewed from another aspect.

FIG. 3 is an assembled view of the battery cover latching mechanism, showing the battery cover latching mechanism assembled to the electronic device.

FIG. 4 is an assembled cross-sectional view taken along line VI-VI of FIG. 3, showing the battery cover latching mechanism in a locked state.

FIG. 5 is an assembled cross-sectional view taken along line VI-VI of FIG. 3, showing the battery cover latching mechanism in an unlocked state.

FIG. 6 is an enlarged view of a circled portion VI of the battery cover latching mechanism shown in FIG. 5.

### DETAILED DESCRIPTION

Embodiments of the present disclosure will now be described in detail below, with reference to the accompanying drawings.

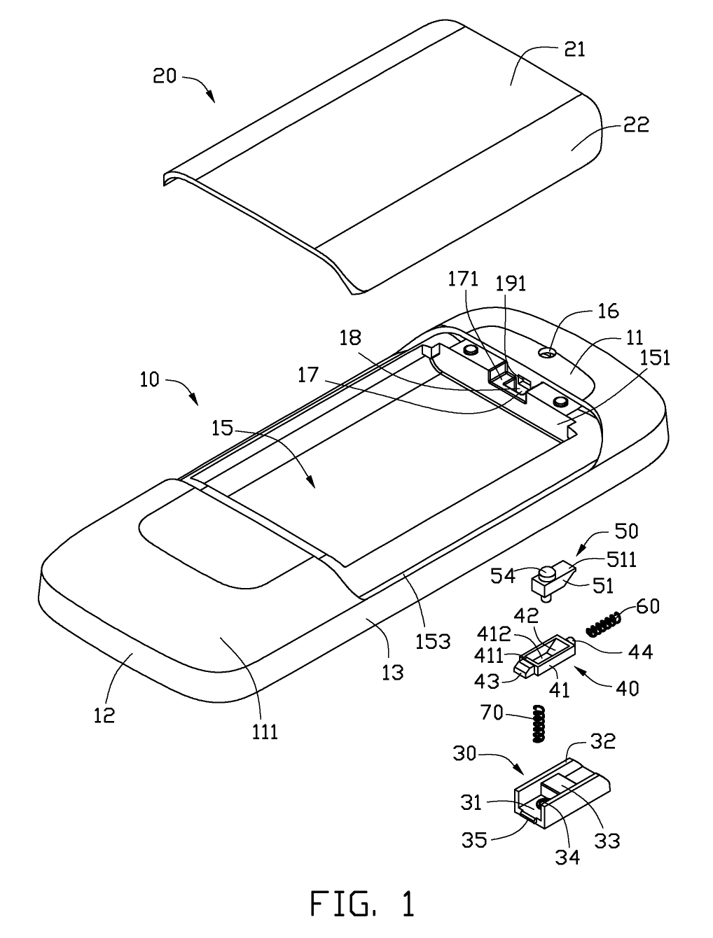

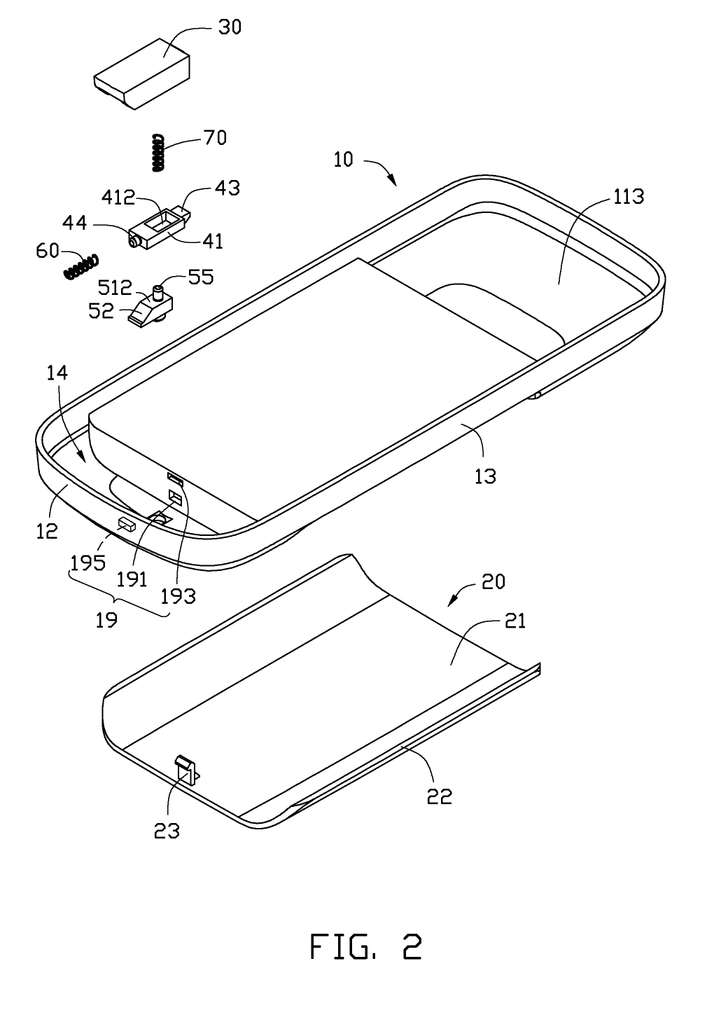

FIGS. 1 and 2 show an exemplary embodiment of a battery cover latching mechanism used in an electronic device 100, which may be a mobile phone, or a personal digital assistant (PDA). The mobile phone is used here as an example for the purpose of describing the details of the battery cover latching mechanism. The electronic device 100 includes a housing 10 and a battery cover 20.

The battery cover 20 is detachably assembled to the housing 10 through the battery cover latching mechanism. The battery cover latching mechanism is detachably mounted on the housing 10, and is positioned between the housing 10 and the battery cover 20 to secure a battery within the housing 10 and provide latching and unlatching of the battery cover 20 relative to the housing 10. The battery cover latching mechanism includes a hook 23, a base body 30, a sliding element 40, an operating element 50, a first elastic element 60, and a second elastic element 70.

The housing 10 includes a main plate 11, an end edge 12, and two opposite side edges 13. A receiving space 15 is defined in substantially the middle of the main plate 11 to receive and secure the battery. The main plate 11 includes an outer surface 111 and an inner surface 113 opposite to the outer surface 111. The two side edges 13 are connected to opposite ends of the end edge 12. The receiving space 15 is formed on the outer surface 111, receding towards the inner surface 113. The receiving space 15 includes an end wall 151 opposite to the end edge 12. The end wall 151, the end edge 12, and the inner surface 113 form an accommodating space 14. An assembling surface 153 is formed around the receiving space 15, receding down towards the outer surface 111. The assembling surface 153 is capable of securing the battery cover 20.

The housing 10 defines a button hole 16, a rectangular opening 17, and an accepting slot 18. The button hole 16 is located at the main plate 11 and is adjacent to the receiving space 15. The opening 17 is substantially positioned in the middle or adjacent to the middle of the end wall 151, and is adjacent to the button hole 16. The opening 17 communicates with the receiving space 15 and includes a bottom surface 171. The accepting slot 18 is defined and positioned on the bottom surface 171.

The housing 10 further includes a locking element 19. The locking element 19 includes a through hole 191, a locking slot 193, and locking block 195. The through hole 191 passes through the end wall 151, so the accommodating space 14 can communicate with the accepting slot 18 via the through hole 191. The locking slot 193 is adjacent to the through hole 191, and is positioned on the end wall 151, and communicates with the accommodating space 14. The locking block 195 is aligned with the locking slot 193 and protrudes from the inner surface of the end edge 12 towards the accommodation space 14.

The battery cover 20 includes a press cover 21 and two side plates 22 located at opposite sides of the press cover 21. The side plates 22 can be formed by bending the opposite sides of the press cover 21. The hook 23 is elasticably positioned on the inner surface of the press plate 21 and corresponds to the accepting slot 18. When the battery cover 20 is assembled to the housing 10, the press plate 21 covers the receiving space 15, the two side plates 22 resist against the assembling surface 153, and the hook 23 is detachably received and secured in the accepting slot 18.

The base body 30 includes a bottom plate 31, two sheet portions 32, a protruding block 33, a groove 34, and a convex portion 35. The bottom plate 31 and the sheet portions 32 are substantially rectangular plates, the two sheet portions 32 are substantially perpendicularly connected to opposite sides of the bottom plate 31. The protruding block 33 is substantially rectangular block and is positioned on the bottom plate 31 and between the two sheet portions 32. The groove 34 is defined in the bottom plate 31 and is adjacent to the protruding block 33. The convex portion 35 is located at one end of the bottom plate 31, and is detachably received in the locking slot 193.

The sliding element 40 includes a frame body 41, a latching block 43, and a first post body 44. The frame body 41 defines a positioning space 412 and includes a first resisting surface 42 and two opposite end frames 411. The latching block 43 protrudes from one of the end frames 411; the first post body 44 protrudes from the other end frame 411. The first resisting surface 42 and the first post body 44 are located at opposite sides of the end frames 411. The sliding element 40 can be detachably assembled within the two sheet portions 32 of the base body 30, and the protruding block 33 slides along the protruding block 33.

The operating element 50 includes a main body 51, a second resisting surface 52, a button 54, and a second post body 55. The size and the shape of the main body 51 substantially match that of the positioning space 412. In this exemplary embodiment, the main body 51 is a substantially right trapezoid and includes a first surface 511 and a second surface 512 parallel to the first surface 511. The second resisting surface 52 connects the first surface 511 and the second surface 512, and has the same slope gradient as the first resisting surface 42 for resisting against each other. The button 54 is positioned on the first surface 511 and can be detachably received in the button hole 16. The second post body 55 is positioned on the second surface 512.

In this exemplary embodiment, the first elastic element 60 and the second elastic element 70 can be cylindrical spiral springs. The first post body 44 can be detachably assembled to the first elastic element 60, and the second post body 55 can be detachably assembled to the second elastic element 70. The first elastic element 60 is capable of providing a restoring elastic force for the sliding element 40; the second elastic element 70 is capable of providing a restoring elastic force for the operating element 50.

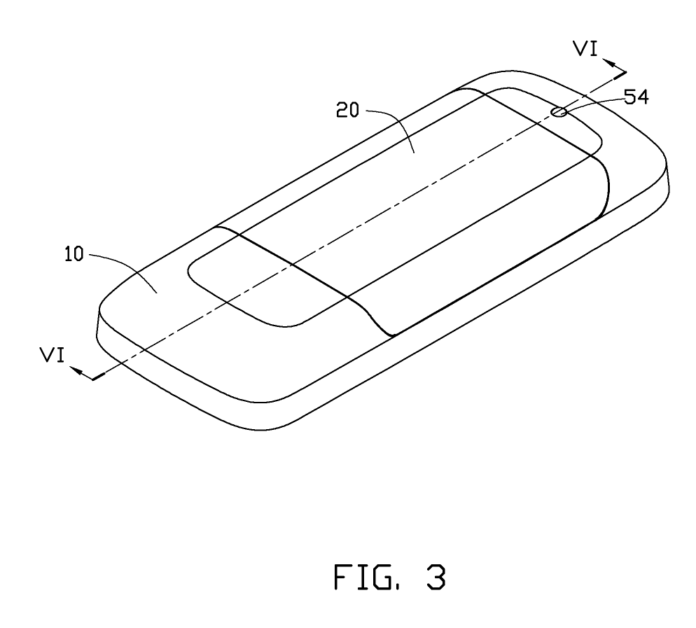

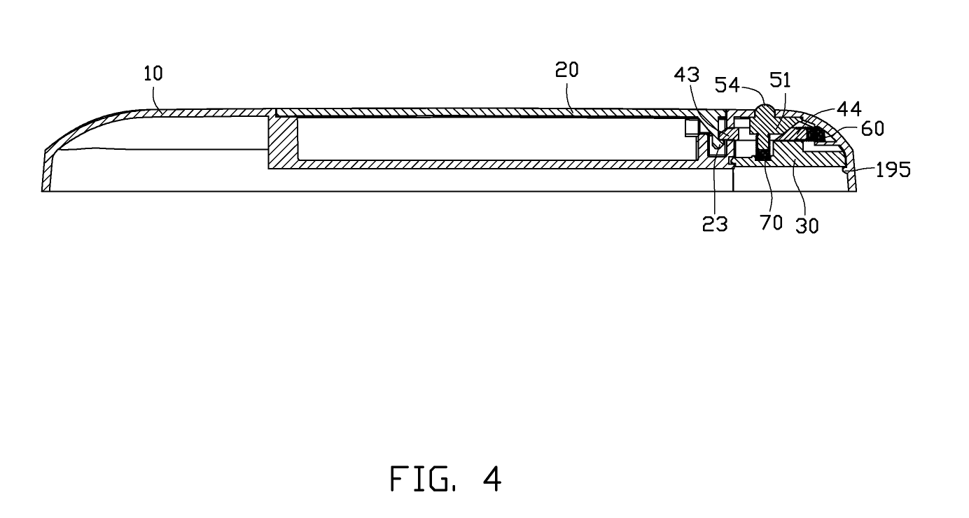

Further referring to FIGS. 3 and 4, in assembly, the second post body 55 of the operating element 50 passes through the positioning space 412 of the sliding element 40, making the first resisting surface 42 resist against the second resisting surface 52, so the operating element 50 is assembled to the sliding element 40. The operating element 50 and the sliding element 40 are received in the accommodating space 14, and the button 54 is aligned with and passes through the button hole 16. The latching block 43 passes through the through hole 191 and is exposed to the accepting slot 18. One end of the first elastic element 60 is located at the first post body 44; the other end resists against the end edge 12 and is secured by the locking block 195, so the first elastic element 60 is in a compressed state. One end of the second elastic element 70 is located at the second post body 55; the other end of the second elastic element 70 is detachably received in the groove 34. The frame body 41 resists against the protruding block 33. The convex portion 35 located at one end of the bottom plate 31 is detachably received in the locking slot 193, and the other end of the bottom plate 31 is secured and locked by the locking block 195. Thus, the battery cover latching mechanism is assembled together.

To lock the battery cover 20 to the housing 10, one end of the press plate 21 is connected to the housing 10 through a hinge mechanism (not shown). Pressing the other end of the housing press plate 21 towards the receiving space 15, the hook 23 is removably received in the accepting slot 18, and is latched by the latching block 43. Due to the elastic deformation of the first elastic element 60, the hook 23, and the latching block 43 maintains a locked state. Thus, the battery cover 20 is latched to the housing 10.

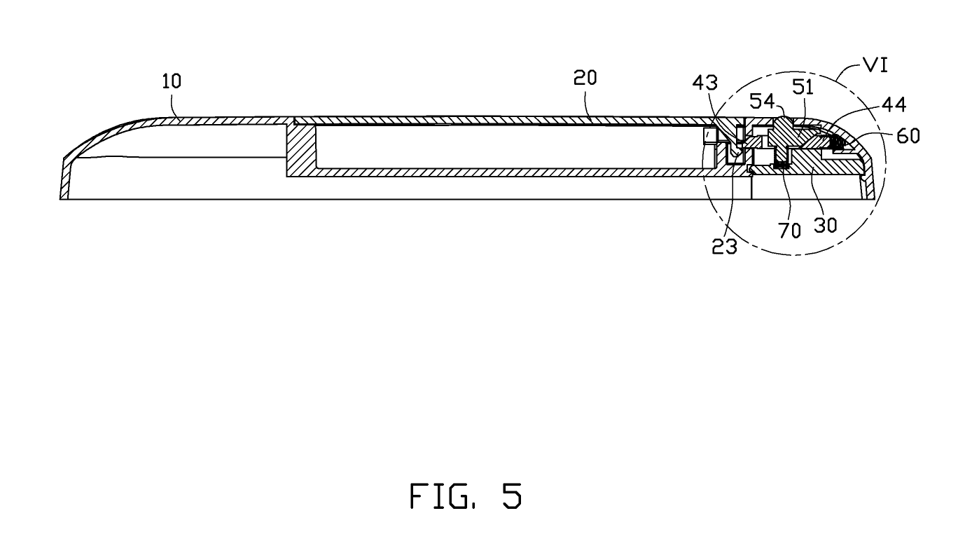

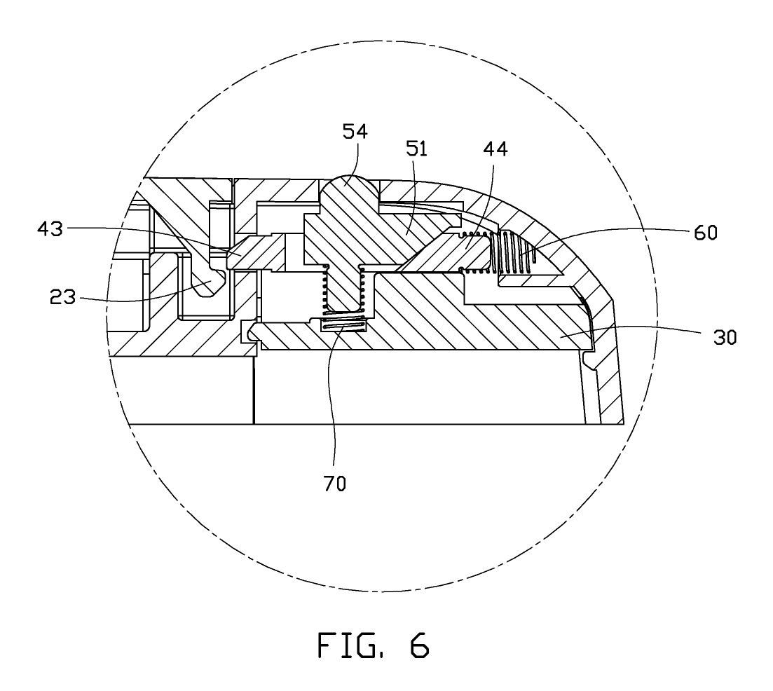

Further referring to FIGS. 5 and 6, to unlock the battery cover 20 from the housing 10, by substantially perpendicularly pressing the button 54 towards the sliding element 40, the second post body 55 pushes and compresses the second elastic element 70, and the second resisting surface 52 slides relative to and pushes the first resisting surface 42. The first post body 44 pushes and compresses the first elastic element 60, the latching block 43 moves in the direction away from the accepting slot 18. Thus, the hook 23 detaches from the latching block 43, the battery cover 20 is unlocked from the housing 10.

In summary, in the battery cover latching mechanism of the exemplary embodiment, by externally pressing the battery cover 20 towards the housing 10, the battery cover 20 is attached and latched to the housing 10. The battery cover 20 can be detached from the housing 10 by operating the button 54 on the housing 10. Moreover, the battery cover latching mechanism has a simple structure and is easy to operate to install or remove the battery.

It is to be understood, however, that even though numerous characteristics and advantages of the exemplary disclosure have been set forth in the foregoing description, together with details of the structure and function of the exemplary disclosure, the disclosure is illustrative only, and changes may be made in detail, especially in matters of shape, size, and arrangement of parts within the principles of exemplary disclosure to the full extent indicated by the broad general meaning of the terms in which the appended claims are expressed.

What is claimed is:

1. A battery cover latching mechanism used to assemble a battery cover to a housing, comprising:
a hook positioned on the battery cover;
a sliding element detachably assembled to the housing, the sliding element comprising a latching block, the latching block corresponding to the hook; and
an operating element detachably and removably assembled to the sliding element, wherein the operating element pushes the sliding element, and the sliding element moves back and forth relative to the operating element, the latching block locks or unlocks the hook to latch or unlatch the battery cover to the housing, respectively.

2. The battery cover latching mechanism as claimed in claim 1, wherein the sliding element further comprises a frame body, the frame body comprises a first resisting surface, and the operating element comprises a second resisting surface and a button, the first resisting surface and the second resisting surface resist against each other.

3. The battery cover latching mechanism as claimed in claim 2, wherein when the button is pressed, the second resisting surface slides relative to the first resisting surface and resistibly pushes the first resisting surface, the operating element forces the sliding element, the latching block is unable to secure and latch the hook to unlock the battery cover.

4. The battery cover latching mechanism as claimed in claim 2, further comprising a first elastic element, wherein the sliding element further comprises a first post body, one end of the first elastic element is located at the first posy body, the other end resists against the housing to enable the latching block to lock the hook.

5. The battery cover latching mechanism as claimed in claim 4, wherein the frame body defines a positioning space, the latching block and the first post body are located at opposite sides of the frame, the first resisting surface is located at an inner side of the positioning space, and the operating element further comprises a main body, the second resisting surface is located at one side surface of the main body, the main body is removably received in the positioning space to make the first resisting surface and the second resisting surface to resist against each other.

6. The battery cover latching mechanism as claimed in claim 4, further comprising a second elastic element and a base body, wherein the operating element further comprises a second post body, the base body defines a groove, one end of the second elastic element is located at the second post body; the other end of the second elastic element is detachably received in the groove to provide a restoring elastic force for the button.

7. The battery cover latching mechanism as claimed in claim 6, wherein the base body further comprises two sheet portions and a protruding block located between the sheet portions, the groove is adjacent to the protruding block, the frame slidably moves along the protruding block of the base body.

8. A battery cover latching mechanism used to assemble a battery cover to a housing, comprising:
a hook positioned on the battery cover;
a base body detachably assembled to the housing;
a sliding element detachably and slidably assembled to the base body, the sliding element comprising a latching block, the latching block corresponding to the hook; and
an operating element detachably and removably assembled to the sliding element, wherein the operating element is operated relative to the sliding element, the operating element forces the sliding element to move relative to the base body, the latching block unlocks the hook to detach the battery cover, when the latching block locks the hook, the battery cover is latched.

9. The battery cover latching mechanism as claimed in claim 8, wherein the sliding element further comprises a frame body, the frame body comprises a first resisting surface, and the operating element comprises a second resisting surface and a button, the first resisting surface and the second resisting surface resist against each other.

10. The battery cover latching mechanism as claimed in claim 9, wherein when the button is pressed, the second resisting surface slides relative to the first resisting surface and resistibly pushes the first resisting surface, the operating element forces the sliding element, the latching block is unable to secure and latch the hook to unlock the battery cover.

11. The battery cover latching mechanism as claimed in claim 9, further comprising a first elastic element, wherein the sliding element further comprises a first post body, one end of the first elastic element is located at the first posy body, the other end resists against the housing to enable the latching block to lock the hook.

12. The battery cover latching mechanism as claimed in claim 11, wherein the frame body defines a positioning space, the latching block and the first post body are located at opposite sides of the frame, the first resisting surface is located at an inner side of the positioning space, and the operating element further comprises a main body, the second resisting surface is located at one side surface of the main body, the main body is removably received in the positioning space to make the first resisting surface and the second resisting surface to resist against each other.

13. The battery cover latching mechanism as claimed in claim 11, further comprising a second elastic element, wherein the operating element further comprises a second post body, the base body defines a groove, one end of the second elastic element is located at the second post body; the other end of the second elastic element is detachably received in the groove to provide a restoring elastic force for the button.

14. The battery cover latching mechanism as claimed in claim 13, wherein the base body further comprises two sheet portions and a protruding block located between the sheet portions, the groove is adjacent to the protruding block, the frame slidably moves along the protruding block of the base body.

15. An electronic device, comprising:
a housing defining a through hole;
a battery cover detachably assembled to the housing; and
a battery cover latching mechanism detachably positioned between the housing and the battery cover, the battery cover latching mechanism comprising:
a hook positioned on the battery cover;
a base body detachably assembled to the housing;
a sliding element detachably and slidably assembled to the base body, the sliding element comprising a latching block, the latching block passing through the through hole and corresponding to the hook; and
an operating element detachably and removably assembled to the sliding element, wherein the operating element is operated relative to the sliding element, the operating element forces the sliding element to move relative to the base body, the latching block locks or unlocks the hook to lock or detach the battery cover from the housing.

16. The electronic device as claimed in claim 15, wherein the sliding element further comprises a frame body, the frame body comprises a first resisting surface, and the operating element comprises a second resisting surface and a button, the first resisting surface and the second resisting surface resist against each other, when the button is pressed, the second resisting surface slides relative to the first resisting surface and resistibly pushes the first resisting surface, the operating element forces the sliding element, the latching block is unable to secure and latch the hook to unlock the battery cover.

17. The electronic device as claimed in claim 16, wherein the battery cover latching mechanism further comprises a first elastic element, the sliding element further comprises a first post body, one end of the first elastic element is located at the first posy body, the other end resists against the housing to enable the latching block to lock the hook.

18. The electronic device as claimed in claim 17, wherein the battery cover latching mechanism further comprises a second elastic element, the operating element further comprises a second post body, the base body defines a groove, one end of the second elastic element is located at the second post body; the other end of the second elastic element is detachably received within the groove to provide a restoring elastic force for the button.

19. The electronic device as claimed in claim 15, wherein the base body further comprises two sheet portions and a protruding block located between the sheet portions, the groove is adjacent to the protruding block, the frame slidably moves along the protruding block of the base body.

20. The electronic device as claimed in claim 15, wherein the housing comprises a main plate and a locking element, the main plate defines a receiving space and an opening, the opening is located at one side surface of receiving space and communicates with the receiving space and the through hole; the locking element comprises a locking slot and a locking block, the locking slot is adjacent to the through hole, the locking block is aligned with the locking slot, the base body is secured between the locking slot and the locking block.
